(19) United States
(12) Patent Application Publication
(10) Pub. No.: US 2024/0094774 A1
(43) Pub. Date: Mar. 21, 2024

(54) FOLDABLE ELECTRONIC APPARATUS

(71) Applicant: SYNCMOLD ENTERPRISE CORP., New Taipei City (TW)

(72) Inventors: Ching-Hui YEN, New Taipei City (TW); Chun-Hao HUANG, New Taipei City (TW); Chien-Cheng YEH, New Taipei City (TW)

(73) Assignee: SYNCMOLD ENTERPRISE CORP., New Taipei City (TW)

(21) Appl. No.: 18/453,704

(22) Filed: Aug. 22, 2023

Related U.S. Application Data
(60) Provisional application No. 63/407,412, filed on Sep. 16, 2022.

(30) Foreign Application Priority Data
Apr. 12, 2023 (TW) 112203336

(51) Int. Cl. G06F 1/16

(52) U.S. Cl. CPC G06F 1/1641; G06F 1/1652

(57) ABSTRACT

A foldable electronic apparatus is provided and includes a base unit and a display unit. The display unit includes a main panel body having a first side and a bottom side substantially perpendicular to each other, and the bottom side is connected to the base unit; a first folding module disposed on the first side; a first side panel body disposed on the first folding module, and the first side panel body is able to transform between a first unfolded state and a first folded state relative to the main panel body with the first folding module as an axis; and a flexible screen disposed on the main panel body, the first folding module and the first side panel body, and the flexible screen includes a first bendable area corresponding to the first folding module.

### CROSS-REFERENCE TO RELATED APPLICATION

This application claims the benefit of U.S. Provisional Application Ser. No. 63/407,412 filed on Sep. 16, 2022, and the benefit of Taiwan Patent Application Serial No. 112203336 filed on Apr. 12, 2023. The entirety of each Application is incorporated herein by reference.

### BACKGROUND

### 1. Technical Field

The present disclosure provides a foldable electronic apparatus, and more particularly, a foldable electronic apparatus having a compact storage volume and a large viewing area.

### 2. Description of Related Art

In recent years, along with the advancement of technology, users have higher and higher requirements for miniaturizing the volume of an electronic display apparatus (such as a laptop computer) being stored. For instance, the volume of the electronic apparatus being stored can be reduced as much as possible by folding the screen of the electronic apparatus, so that the electronic apparatus can be easy to carry. On the other hand, the visual effects of the display screen on the electronic display apparatus will not be reduced when the volume of the electronic display apparatus being stored is miniaturized; that is, when the electronic apparatus is transitioned from the un-storage state to the storage state, the viewing area of the display screen can still maintain excellent visual effects, especially with a large viewing area.

### SUMMARY

The present disclosure provides a foldable electronic apparatus disposed on a work surface, the foldable electronic apparatus comprising: a base unit disposed on the work surface; and a display unit including a main panel body having a first side and a bottom side substantially perpendicular to each other, wherein the bottom side is connected to the base unit; a first folding module disposed on the first side; a first side panel body disposed on the first folding module, wherein the first side panel body is able to transform between a first unfolded state and a first folded state relative to the main panel body with the first folding module as an axis; and a flexible screen disposed on the main panel body, the first folding module and the first side panel body and including a first bendable area corresponding to the first folding module, wherein when the first side panel body is in the first unfolded state, the flexible screen is flattened, and the main panel body and the first side panel body are flattened, and when the first side panel body is in the first folded state, the first side panel body and the main panel body are stacked to each other, and the flexible screen is bent and sandwiched between the first side panel body and the main panel body.

In the aforementioned foldable electronic apparatus, when the first side panel body is in the first folded state, the first folding module has a first yielding space, and the first bendable area of the flexible screen is accommodated in the first yielding space.

In the aforementioned foldable electronic apparatus, the main panel body is able to transform between an open state and a closed state relative to the base unit, and wherein when the main panel body is in the open state, the main panel body is angularly and pivotally connected to the base unit, and when the main panel body is in the closed state and the first side panel body is in the first folded state, the main panel body and the base unit are stacked to each other, and the first side panel body is sandwiched between the main panel body and the base unit.

In the aforementioned foldable electronic apparatus, when the display unit is a foldable tablet computer, the base unit is a detachable external keyboard, and when the display unit is a display screen, the base unit is a host of a laptop computer or a screen supporter.

In the aforementioned foldable electronic apparatus, the first folding module has a central base, a torque member, a left wing member, a left transmission member, a left carrying member, a right wing member, a right transmission member, a right carrying member and a synchronizing member.

In the aforementioned foldable electronic apparatus, the display unit further includes a second folding module and a second side panel body, the main panel body further has a second side opposing the first side, and the flexible screen further includes a second bendable area, and wherein the second folding module is disposed on the second side, the second side panel body is disposed on the second folding module and is able to transform between a second unfolded state and a second folded state relative to the main panel body with the second folding module as an axis, the flexible screen is disposed on the main panel body, the first folding module, the first side panel body, the second folding module and the second side panel body, and the second bendable area corresponds to the second folding module.

In the aforementioned foldable electronic apparatus, when the second side panel body is in the second folded state, the second folding module has a second yielding space, and the second bendable area of the flexible screen is accommodated in the second yielding space.

In the aforementioned foldable electronic apparatus, when the first side panel body is in the first unfolded state and the second side panel body is in the second unfolded state, the flexible screen is flattened, and the main panel body, the first side panel body and the second side panel body are flattened, and when the second side panel body is in the second folded state, the second side panel body and the main panel body are stacked to each other, and the flexible screen is bent and sandwiched between the second side panel body and the main panel body.

In the aforementioned foldable electronic apparatus, when the main panel body is in the open state, the main panel body is angularly and pivotally connected to the base unit, and when the main panel body is in the closed state, the first side panel body is in the first folded state and the second side panel body is in the second folded state, the main panel body and the base unit are stacked to each other, and the first side panel body and the second side panel body are sandwiched between the main panel body and the base unit.

In the aforementioned foldable electronic apparatus, the first side panel body is further able to transform to a first intermediate state between the first unfolded state and the first folded state relative to the main panel body, and the second side panel body is further able to transform to a second intermediate state between the second unfolded state and the second folded state relative to the main panel body.

In the aforementioned foldable electronic apparatus, a width of the main panel body is equal to a sum of a width of the first side panel body and a width of the second side panel body.

In the aforementioned foldable electronic apparatus, the display unit further includes a male sliding component and a female sliding component slidably disposed with each other, the male sliding component is disposed on one of the bottom side and the base unit, and the female sliding component is disposed on the other one of the bottom side and the base unit, such that the main panel body is able to slide relative to the base unit.

In the aforementioned foldable electronic apparatus, a distance that the main panel body is able to slide relative to the base unit is half of a length of the bottom side, and a width of the first side panel body is equal to a width of the main panel body.

In the aforementioned foldable electronic apparatus, the display unit further includes a flat screen, the first side panel body has a front side and a back side opposing the front side, the flexible screen is disposed on the front side, and the flat screen is disposed on the back side.

### BRIEF DESCRIPTION OF THE DRAWINGS

FIG. 1 is a schematic overall view of a foldable electronic apparatus according to a first embodiment of the present disclosure.

FIG. 2 is a schematic exploded view of the foldable electronic apparatus according to the first embodiment of the present disclosure.

FIG. 3 is a schematic view of a first folding module being unfolded according to the first embodiment of the present disclosure.

FIG. 4 is a schematic view of the first folding module being folded according to the first embodiment of the present disclosure.

FIG. 5 is a schematic view of a main panel body being in a closed state according to the first embodiment of the present disclosure.

FIG. 6 is a schematic view of the main panel body being in an open state, a first side panel body being in a first folded state and a second side panel body being in a second folded state according to the first embodiment of the present disclosure.

FIG. 7 is a schematic view of the main panel body being in the open state, the first side panel body being in a first unfolded state and the second side panel body being in a second unfolded state according to the first embodiment of the present disclosure.

FIG. 8 is a schematic overall view of the foldable electronic apparatus according to a second embodiment of the present disclosure.

FIG. 9 is a schematic exploded view of a male sliding component and a female sliding component according to the second embodiment of the present disclosure.

FIG. 10 is a schematic view of the main panel body being in the open state, the first side panel body being in the first unfolded state and the main panel body being not sliding according to the second embodiment of the present disclosure.

FIG. 11 is a schematic view of the main panel body being in the open state, the first side panel body being in the first unfolded state and the main panel body being sliding according to the second embodiment of the present disclosure.

### DETAILED DESCRIPTIONS

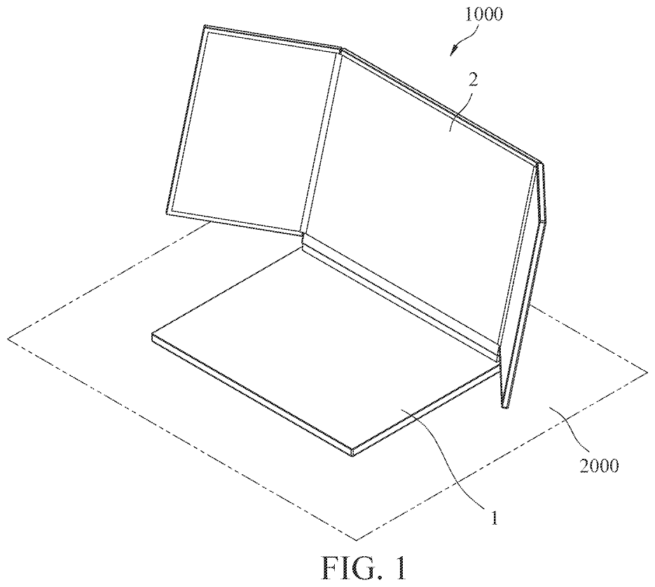

Please refer to FIG. 1, in a first embodiment of the present disclosure, a foldable electronic apparatus 1000 is disposed on a work surface 2000 (such as a desktop). The foldable electronic apparatus 1000 comprises a base unit 1 and a display unit 2 connected to the base unit 1. The structure of each element and the connection relationship between each element are described in detail below.

The base unit 1 is disposed on the work surface 2000 and can be an external keyboard, a host of a laptop computer, or a screen supporter, but it is not limited to these.

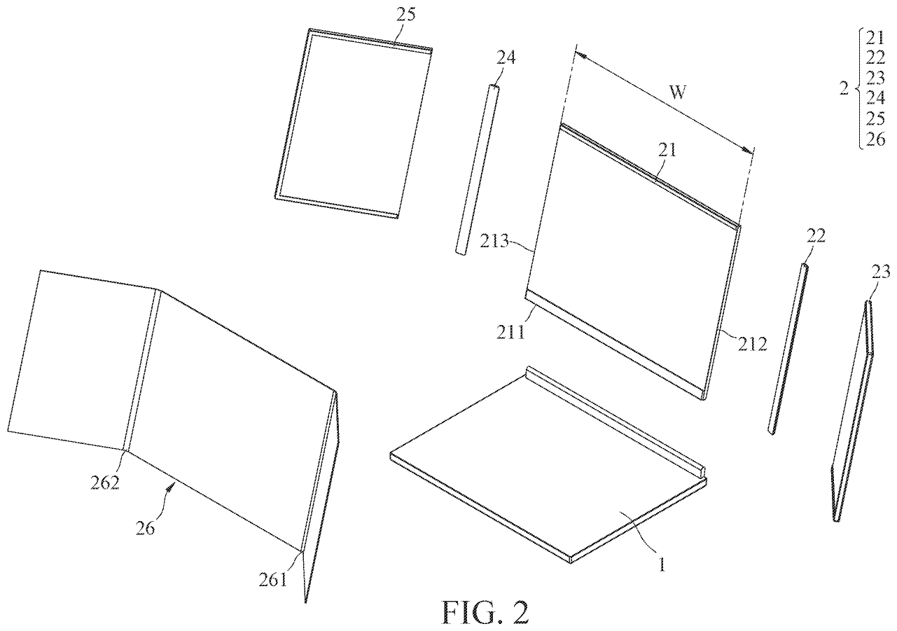

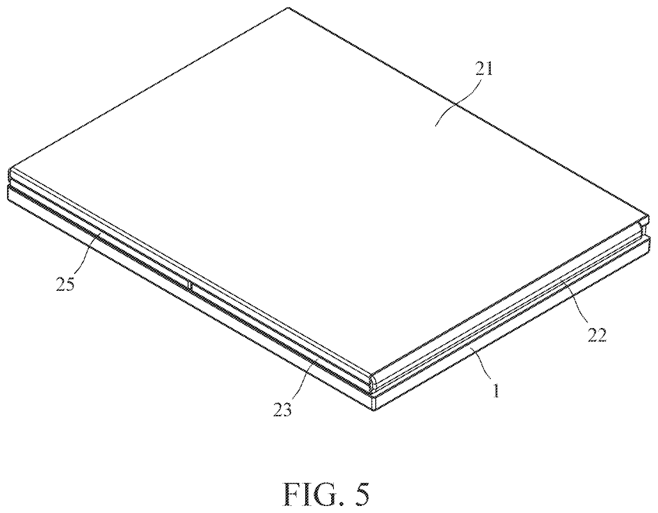

Please refer to FIG. 2, the display unit 2 comprises a main panel body 21, a first folding module 22, a first side panel body 23, a second folding module 24, a second side panel body 25 and a flexible screen 26. The main panel body 21 is a plate body roughly in the shape of a square and has a bottom side 211, a first side 212 and a second side 213. The width of the main panel body 21 (i.e., the length of the bottom side 211) is W, and the bottom side 211 is pivotally connected to a side of the base unit 1, such that the main panel body 21 is able to transform between an open state (FIG. 1) and a closed state (FIG. 5) relative to the base unit 1. The first side 212 and the second side 213 correspond to each other and are respectively perpendicular to the bottom side 211.

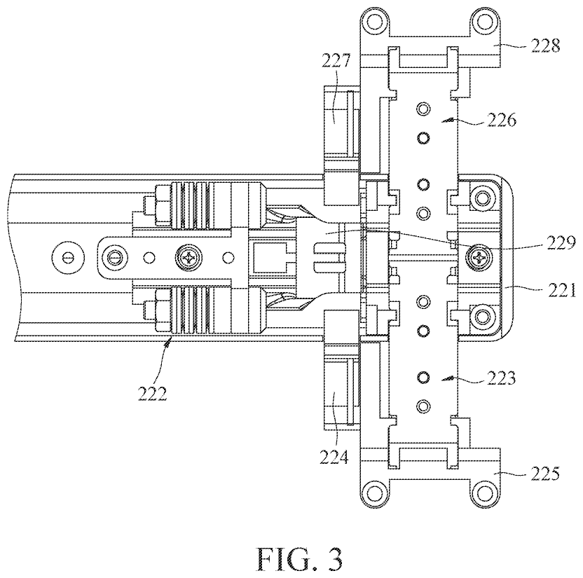

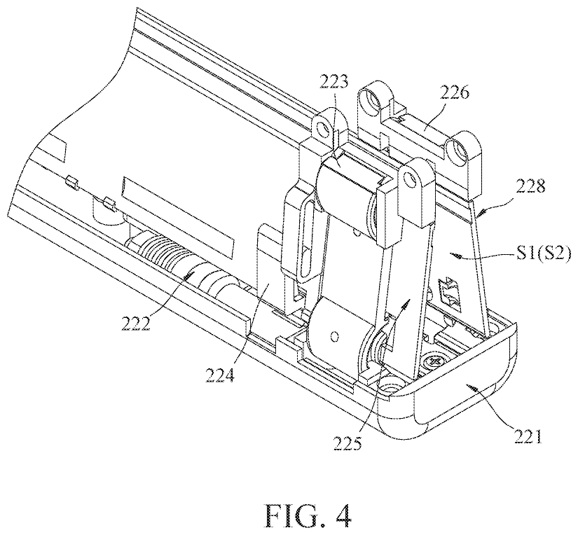

Please refer to FIG. 3 and FIG. 4 at the same time, the first folding module 22 is disposed on the first side 212 and has a central base 221, a torque member 222, a left wing member 223, a left transmission member 224, a left carrying member 225, a right wing member 226, a right transmission member 227, a right carrying member 228 and a synchronizing member 229. The central base 221 is in the shape of a long block, and the extension direction of the central base 221 is parallel to the extension direction of the first side 212. The torque member 222 is disposed on the central base 221 and constantly provides an elastic force. One end of the left wing member 223 is pivotally connected to a side of the central base 221. The left transmission member 224 is pivotally connected to the torque member 222 and the central base 221. The left carrying member 225 is pivotally connected to another end of the left wing member 223, allows the left transmission member 224 to partially and slidably dispose therein, and is used for connecting the first side 212 of the main panel body 21. One end of the right wing member 226 is pivotally connected to another side of the central base 221. The right transmission member 227 is pivotally connected to the torque member 222 and the central base 221 and is spaced apart from the left transmission member 224. The right carrying member 228 is pivotally connected to another end of the right wing member 226 and allows the right transmission member 227 to partially and slidably dispose therein. The synchronizing member 229 is slidably disposed between the left transmission member 224 and the right transmission member 227 and on the central base 221. The synchronizing member 229 is used to allow the left transmission member 224 and the right transmission member 227 to rotate synchronously and reversely, and at the same time allow the left transmission member 224 and the right transmission member 227 to generate friction with the synchronizing member 229. In other embodiments, the first folding module 22 can have another group of central base 221, torque member 222, left wing member 223, left transmission member 224, left carrying member 225, right wing member 226, right transmission member 227, right carrying member 228 and synchronizing member 229, which are spaced apart from each other and disposed reversely and symmetrically along the extension direction of the first side 212 respectively (at this time, the right carrying member 228 can be used to connect the first side 212 of the main panel body 21), but the first folding module 22 is not limited to this, and the first folding module 22 can have more than two groups.

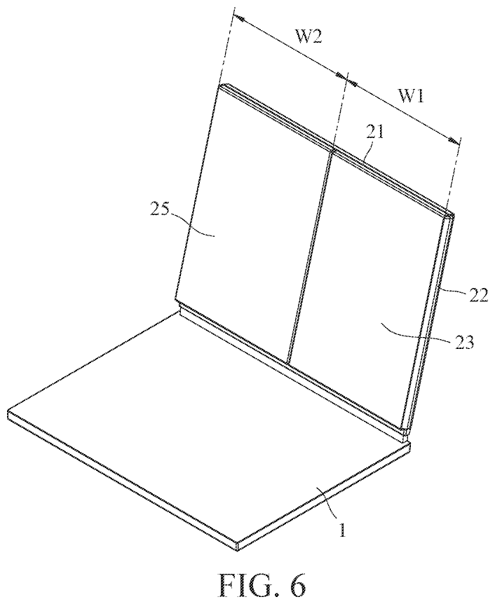

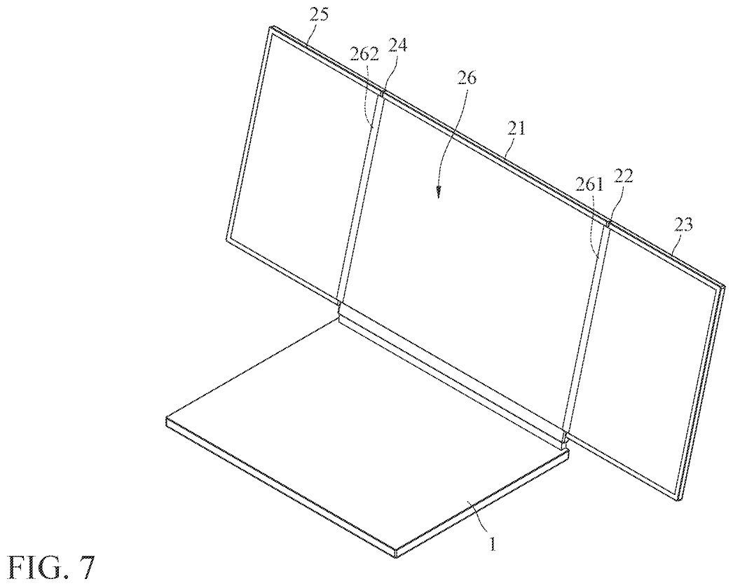

The first side panel body 23 is a plate body roughly in the shape of a square and is disposed on the right carrying member 228 of the first folding module 22 (when the right carrying member 228 is connected to the first side 212, the first side panel body 23 is disposed on the left carrying member 225). The first side panel body 23 is able to transform between a first unfolded state (FIG. 7), a first intermediate state (FIG. 1) and a first folded state (FIG. 6) relative to the main panel body 21 with the first folding module 22 as the axis, and the first side panel body 23 has a width W1, wherein the first intermediate state is between the first unfolded state and the first folded state. The second folding module 24 is disposed on the second side 213, and the structure and the quantity of the second folding module 24 are the same as those of the first folding module 22, which will not be repeated here. The second side panel body 25 is a plate body roughly in the shape of a square and is disposed on the second folding module 24. The second side panel body 25 is able to transform between a second unfolded state (FIG. 7), a second intermediate state (FIG. 1) and a second folded state (FIG. 6) relative to the main panel body 21 with the second folding module 24 as the axis, and the second side panel body 25 has a width W2, wherein the second intermediate state is between the second unfolded state and the second folded state. In an embodiment, a width W of the main panel body 21 is equal to the sum of the width W1 of the first side panel body 23 and the width W2 of the second side panel body 25, and the width W1 is equal to the width W2, but it is not limited to this, the width W1 can also be not equal to the width W2.

The flexible screen 26 is disposed on the main panel body 21, the first folding module 22, the first side panel body 23, the second folding module 24 and the second side panel body 25 and comprises a first bendable area 261 and a second bendable area 262, wherein the first bendable area 261 roughly corresponds to the first folding module 22, and the second bendable area 262 roughly corresponds to the second folding module 24.

In an embodiment, when the base unit 1 is an external keyboard, the display unit 2 can be a foldable tablet computer that can be assembled with or disassembled from the external keyboard, but it is not limited to this. The display unit 2 can be a display screen when the base unit 1 is a host of a laptop computer. In other embodiments, the base unit 1 can also be a screen supporter for supporting a display screen or a foldable tablet computer.

The actuation of the foldable electronic apparatus 1000 according to the first embodiment of the present disclosure is described below. As shown in FIG. 5, when the main panel body 21 is in the closed state and the first side panel body 23 is in the first folded state, the main panel body 21 and the base unit 1 are stacked to each other (i.e., the angle between the main panel body 21 and the base unit 1 is 0 degrees for example), and the first side panel body 23 is sandwiched between the main panel body 21 and the base unit 1 (the angle between the first side panel body 23 and the main panel body 21 is 0 degrees for example). Similarly, when the main panel body 21 is in the closed state and the second side panel body 25 is in the second folded state, the main panel body 21 and the base unit 1 are stacked to each other, and the second side panel body 25 is sandwiched between the main panel body 21 and the base unit 1. At this time, a first yielding space S1 is formed between and around the left carrying member 225, the right carrying member 228 and the central base 221 (FIG. 4), and the first bendable area 261 is accommodated in the first yielding space S1 and is roughly in the shape of a water drop. Similarly, a second yielding space S2 is formed in the second folding module 24 to accommodate the second bendable area 262. In practice, the first folding module 22 and the second folding module 24 can also be replaced by other similar mechanisms, as long as the first yielding space S1 and the second yielding space S2 can be formed to accommodate the first bendable area 261 and the second bendable area 262 respectively in the folded state.

As shown in FIG. 6, when the main panel body 21 is in the open state and the first side panel body 23 is in the first folded state, the main panel body 21 is angularly and pivotally connected to the base unit 1 (i.e., the angle between the main panel body 21 and the base unit 1 is 120 degrees for example), the first side panel body 23 and the main panel body 21 are stacked to each other, and the flexible screen 26 is bent and sandwiched between the first side panel body 23 and the main panel body 21, and at this time the first bendable area 261 is still accommodated in the first yielding space S1. Similarly, when the main panel body 21 is in the open state and the second side panel body 25 is in the second folded state, the second side panel body 25 and the main panel body 21 are stacked to each other, and the flexible screen 26 is bent and sandwiched between the second side panel body 25 and the main panel body 21, and at this time the second bendable area 262 is still accommodated in the second yielding space S2.

When the first side panel body 23 is transformed from the first folded state to the first intermediate state (the angle between the first side panel body 23 and the main panel body 21 is 150 degrees for example), at this time the left wing member 223, the left transmission member 224, the left carrying member 225, the right wing member 226, the right transmission member 227 and the right carrying member 228 are synchronously and reversely pivoted on the central base 221 via the synchronizing member 229, such that the first side panel body 23 is angularly and pivotally connected to the main panel body 21. Similarly, when the second side panel body 25 is transformed from the second folded state to the second intermediate state, the second side panel body 25 is angularly and pivotally connected to the main panel body 21 via the second folding module 24.

As shown in FIG. 7, when the first side panel body 23 is transformed from the first intermediate state to the first unfolded state (the angle between the first side panel body 23 and the main panel body 21 is 180 degrees for example) and when the second side panel body 25 is transformed from the second intermediate state to the second unfolded state, the flexible screen 26 is flattened and the main panel body 21, the first side panel body 23 and the second side panel body 25 are flattened, so that the flexible screen 26 presents a large viewing area. Conversely, as long as the first side panel body 23 is transformed to the first folded state first, the second side panel body 25 is transformed to the second folded state, and then the main panel body 21 is transformed to the closed state, the volume of the foldable electronic apparatus 1000 can be minimized.

In summary, in the foldable electronic apparatus 1000 according to the first embodiment of the present disclosure, the first side panel body 23 and the second side panel body 25 are designed to be able to pivot relative to the main panel body 21, so that after the foldable electronic apparatus 1000 is folded, the first side panel body 23 and the second side panel body 25 are sandwiched between the main panel body 21 and the base unit 1, and the flexible screen 26 is bent, such that the volume of the foldable electronic apparatus 1000 can be effectively miniaturized. Further, when the foldable electronic apparatus 1000 is unfolded, the main panel body 21, the first side panel body 23 and the second side panel body 25 can jointly support the flexible screen 26 to present a large viewing area, thereby ensuring excellent visual effects. Furthermore, the first side panel body 23 and the second side panel body 25 can be stopped during the transformation process and respectively sandwich an arbitrary angle with the main panel body 21, thereby providing the user a visual experience similar to a curved screen.

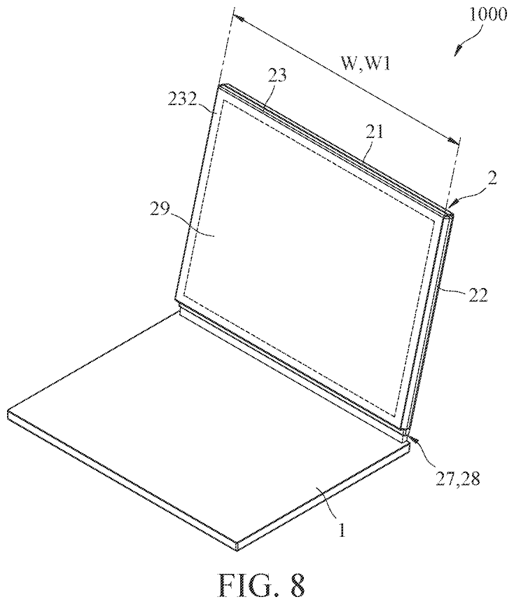

Please refer to FIG. 8 to FIG. 10, in a second embodiment of the present disclosure, the foldable electronic apparatus 1000 is disposed on a work surface 2000 (such as a desktop). The foldable electronic apparatus 1000 comprises a base unit 1 and a display unit 2 connected to the base unit 1, wherein the display unit 2 comprises a main panel body 21, a first folding module 22, a first side panel body 23, a flexible screen 26, a male sliding component 27, a female sliding component 28 and a flat screen 29. The differences between the second embodiment and the first embodiment are that the second folding module 24 and the second side panel body 25 are omitted and the male sliding component 27, the female sliding component 28 and the flat screen 29 are added in the second embodiment. Only the differences are described below, and the same technical content will not be repeated.

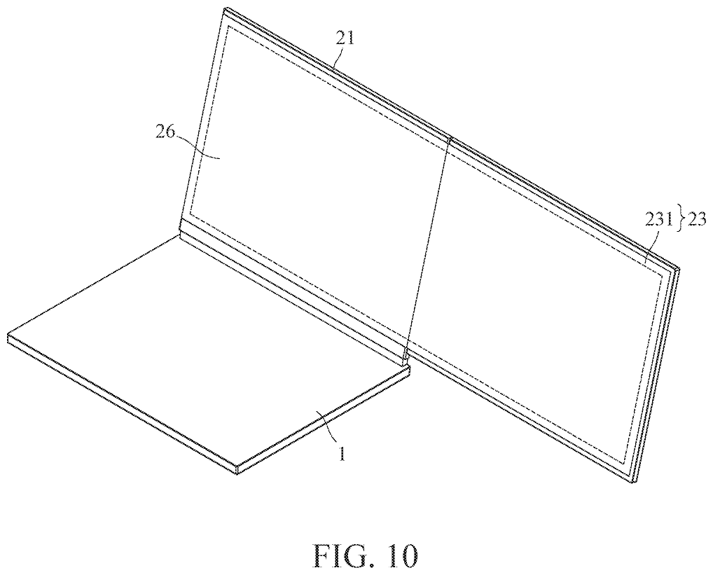

The first side panel body 23 is a plate body roughly in the shape of a square and is disposed on the first folding module 22. The first side panel body 23 is able to transform between a first unfolded state (FIG. 10) and a first folded state (FIG. 8) relative to the main panel body 21 with the first folding module 22 as the axis, and the first side panel body 23 has a width W1, a front side 231 and a back side 232 opposing the front side 231. A width W of the main panel body 21 is equal to the width W1 of the first side panel body 23, but it is not limited to this. As shown in FIG. 10, the flexible screen 26 is disposed on the front side 231 of the first side panel body 23 and the main panel body 21.

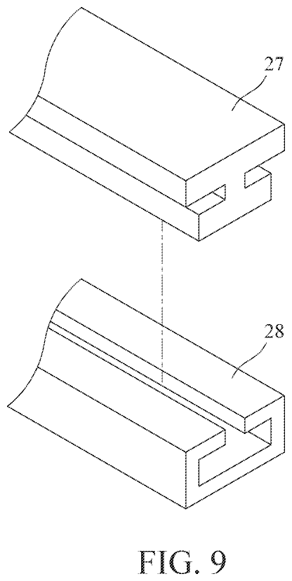

Please refer to FIG. 9 at the same time, the male sliding component 27 is disposed on the bottom side 211 of the main panel body 21 at the same time, the female sliding component 28 is disposed on the base unit 1, and the male sliding component 27 and the female sliding component 28 can be slidably disposed and assembled with each other, so that the main panel body 21 can slide relative to the base unit 1, and the sliding distance is half of a length of the bottom side 211. In an embodiment, the male sliding component 27 can be a T-shaped bump, and the female sliding component 28 can be a guiding rail corresponding to the T-shaped bump, but they are not limited to these. For instance, the male sliding component 27 and the female sliding component 28 can be a three-sectioned sliding rail group. The flat screen 29 is disposed on the back side 232 of the first side panel body 23.

The actuation of the foldable electronic apparatus 1000 according to the second embodiment of the present disclosure is described below. When the main panel body 21 is in the closed state and the first side panel body 23 is in the first folded state, the main panel body 21 and the base unit 1 are stacked to each other, and the first side panel body 23 is sandwiched between the main panel body 21 and the base unit 1.

As shown in FIG. 8, when the main panel body 21 is in the open state and the first side panel body 23 is in the first folded state, the main panel body 21 is angularly and pivotally connected to the base unit 1, the flat screen 29 is facing toward the user to let the user to use, the first side panel body 23 and the main panel body 21 are stacked to each other, and the flexible screen 26 is bent and sandwiched between the first side panel body 23 and the main panel body 21, and at this time a first yielding space S1 is formed between and around the left carrying member 225, the right carrying member 228 and the central base 221, and the first bendable area 261 is accommodated in the first yielding space S1 and is roughly in the shape of a water drop (e.g., FIG. 4).

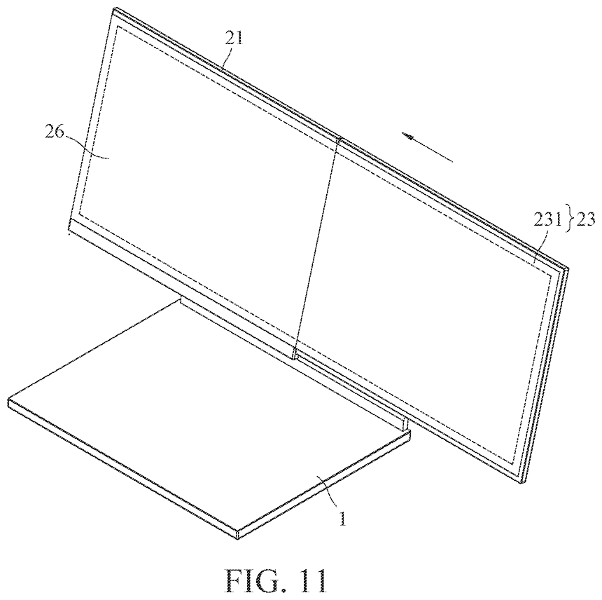

As shown in FIG. 10, the first side panel body 23 is transformed to the first unfolded state, and the flexible screen 26 is flattened, so that the flexible screen 26 presents a large viewing area. Then, as shown in FIG. 11, the main panel body 21 slides relative to the base unit 1 via the male sliding component 27 and the female sliding component 28 until the first side 212 roughly corresponds to the middle of the base unit 1, that is, the sliding distance of the main panel body 21 is half of the width W, but it is not limited to this. Conversely, as long as the first side panel body 23 is transformed from the first unfolded state to the first folded state, and at the same time the main panel body 21 is slid to allow the first side 212 to align with the side of the base unit 1, the main panel body 21 can be transformed to a closed state, thereby allowing the volume of the foldable electronic apparatus 1000 to be effectively miniaturized.

In summary, in the foldable electronic apparatus 1000 according to the second embodiment of the present disclosure, the first side panel body 23 is designed to be able to pivot relative to the main panel body 21, and the main panel body 21 is designed to be able to slide relative to the base unit 1, so that after the foldable electronic apparatus 1000 is folded, the first side panel body 23 is sandwiched between the main panel body 21 and the base unit 1, and the flexible screen 26 is bent, such that the volume of the foldable electronic apparatus 1000 can be effectively miniaturized. Further, by sliding the main panel body 21 relative to the position of the base unit 1 and unfolding the first side panel body 23, the main panel body 21 and the first side panel body 23 can jointly support the flexible screen 26 to present a large viewing area, thereby ensuring excellent visual effects. Even if the first side panel body 23 is not unfolded, the flat screen 29 can still be used, so that the foldable electronic apparatus 1000 has the function of being convenient to use.

What is claimed is:

1. A foldable electronic apparatus disposed on a work surface, the foldable electronic apparatus comprising:
a base unit disposed on the work surface; and
a display unit including:
a main panel body having a first side and a bottom side substantially perpendicular to each other, wherein the bottom side is connected to the base unit;
a first folding module disposed on the first side;
a first side panel body disposed on the first folding module, wherein the first side panel body is able to transform between a first unfolded state and a first folded state relative to the main panel body with the first folding module as an axis; and
a flexible screen disposed on the main panel body, the first folding module and the first side panel body and including a first bendable area corresponding to the first folding module,
wherein when the first side panel body is in the first unfolded state, the flexible screen is flattened, and the main panel body and the first side panel body are flattened, and when the first side panel body is in the first folded state, the first side panel body and the main panel body are stacked to each other, and the flexible screen is bent and sandwiched between the first side panel body and the main panel body.

2. The foldable electronic apparatus of claim 1, wherein when the first side panel body is in the first folded state, the first folding module has a first yielding space, and the first bendable area of the flexible screen is accommodated in the first yielding space.

3. The foldable electronic apparatus of claim 2, wherein the main panel body is able to transform between an open state and a closed state relative to the base unit, and wherein when the main panel body is in the open state, the main panel body is angularly and pivotally connected to the base unit, and when the main panel body is in the closed state and the first side panel body is in the first folded state, the main panel body and the base unit are stacked to each other, and the first side panel body is sandwiched between the main panel body and the base unit.

4. The foldable electronic apparatus of claim 3, wherein when the display unit is a foldable tablet computer, the base unit is a detachable external keyboard, and when the display unit is a display screen, the base unit is a host of a laptop computer or a screen supporter.

5. The foldable electronic apparatus of claim 4, wherein the first folding module has a central base, a torque member, a left wing member, a left transmission member, a left carrying member, a right wing member, a right transmission member, a right carrying member and a synchronizing member.

6. The foldable electronic apparatus of claim 5, wherein the display unit further includes a second folding module and a second side panel body, the main panel body further has a second side opposing the first side, and the flexible screen further includes a second bendable area, and wherein the second folding module is disposed on the second side, the second side panel body is disposed on the second folding module and is able to transform between a second unfolded state and a second folded state relative to the main panel body with the second folding module as an axis, the flexible screen is disposed on the main panel body, the first folding module, the first side panel body, the second folding module and the second side panel body, and the second bendable area corresponds to the second folding module.

7. The foldable electronic apparatus of claim 6, wherein when the second side panel body is in the second folded state, the second folding module has a second yielding space, and the second bendable area of the flexible screen is accommodated in the second yielding space.

8. The foldable electronic apparatus of claim 7, wherein when the first side panel body is in the first unfolded state and the second side panel body is in the second unfolded state, the flexible screen is flattened, and the main panel body, the first side panel body and the second side panel body are flattened, and when the second side panel body is in the second folded state, the second side panel body and the main panel body are stacked to each other, and the flexible screen is bent and sandwiched between the second side panel body and the main panel body.

9. The foldable electronic apparatus of claim 8, wherein when the main panel body is in the open state, the main panel body is angularly and pivotally connected to the base unit, and when the main panel body is in the closed state, the first side panel body is in the first folded state and the second side panel body is in the second folded state, the main panel body and the base unit are stacked to each other, and the first side panel body and the second side panel body are sandwiched between the main panel body and the base unit.

10. The foldable electronic apparatus of claim 9, wherein the first side panel body is further able to transform to a first intermediate state between the first unfolded state and the first folded state relative to the main panel body, and the second side panel body is further able to transform to a second intermediate state between the second unfolded state and the second folded state relative to the main panel body.

11. The foldable electronic apparatus of claim 10, wherein a width of the main panel body is equal to a sum of a width of the first side panel body and a width of the second side panel body.

12. The foldable electronic apparatus of claim 1, wherein the display unit further includes a male sliding component and a female sliding component slidably disposed with each other, the male sliding component is disposed on one of the bottom side and the base unit, and the female sliding component is disposed on the other one of the bottom side and the base unit, such that the main panel body is able to slide relative to the base unit.

13. The foldable electronic apparatus of claim 12, wherein a distance that the main panel body is able to slide relative to the base unit is half of a length of the bottom side, and a width of the first side panel body is equal to a width of the main panel body.

14. The foldable electronic apparatus of claim 13, wherein the display unit further includes a flat screen, the first side panel body has a front side and a back side opposing the front side, the flexible screen is disposed on the front side, and the flat screen is disposed on the back side.
